(19) United States
(12) Patent Application Publication
(10) Pub. No.: US 2026/0008220 A1
(43) Pub. Date: Jan. 8, 2026

(54) RESIN MOLDING METHOD AND RESIN SORTING METHOD

(71) Applicant: Konica Minolta, Inc., Tokyo (JP)

(72) Inventors: Hiroyuki YASUKAWA, Tokyo (JP); Yuya SATO, Tokyo (JP); Kunihiro OGURA, Tokyo (JP); Teruo SASAKI, Tokyo (JP); Hideya MIWA, Tokyo (JP); Seisuke MAEDA, Tokyo (JP)

(21) Appl. No.: 19/254,133

(22) Filed: Jun. 30, 2025

(30) Foreign Application Priority Data
Jul. 3, 2024 (JP) 2024-107279

(51) Int. Cl. B29C 45/78

(52) U.S. Cl. CPC B29C 45/78; B29C 2945/76063; B29C 2945/76347; B29C 2945/76488; B29C 2945/76531

(57) ABSTRACT

A resin molding method includes a physical property estimation step and a molding step. In The physical property estimation step, a resin is irradiated with electromagnetic waves including near-infrared rays; electromagnetic wave intensity of electromagnetic waves reflected by a surface of the resin is estimated; and flowability of the resin is estimated, based on electromagnetic wave intensity information that includes the electromagnetic wave intensity. In the molding step, a molding condition is adjusted, based on the estimated flowability of the resin; and the resin is molded under the adjusted molding condition.

### CROSS-REFERENCE TO RELATED APPLICATIONS

The entire disclosure of Japanese Patent Application No. 2024-107279 filed on Jul. 3, 2024 is incorporated herein by reference in its entirety.

### BACKGROUND OF THE INVENTION

The present invention relates to a resin molding method and a resin sorting method.

### TECHNICAL FIELD

In recent years, the use of recycled resins made of waste plastics has been promoted along with increasing environmental awareness. As raw materials for recycled resins, easily recyclable materials and waste plastics with little variation in physical property are selected and used today. However, in the future, society will be required to reduce the global environmental load, and the demand for recycling plastics will increase. It is therefore necessary to obtain waste plastics from various sources to ensure the quality and quantity of recycled resins. The waste plastics of various sources may include low-quality waste plastics. Examples of the low-quality waste plastics include waste plastics that have largely degraded after multiple times of recycling. The examples further include waste plastics containing multiple additives or impurities.

It is necessary to swiftly detect the physical property of waste plastics as a raw material of recycled resins at a waste plastic reception site, a processing site, and so forth, it is also necessary to manage the quality of recycled resins made of waste plastics.

There is a method of controlling the quality of waste plastics by using the MFR of thermoplastic resin as an indicator (see, for example, Japanese Unexamined Patent Publication No. 2009-128032). In the method, the MFR of a thermoplastic resin is estimated to control the quality of the thermoplastic resin. MFR refers to melt mass flow rate.

However, according to the method of JP2009-128032A, it is difficult to accurately perform measurement for thermoplastics having a low viscosity and a large MFR.

The present invention has been made in consideration of the above-mentioned problems and situations. An object of the present invention is to provide a resin molding method capable of estimating a specific physical property of a resin having an unknown physical property by a simple method, adjusting molding conditions based on the estimated physical property, and molding the resin under the adjusted molding conditions.

To solve the above-described problems, the inventors focused on the relationship between information on the electromagnetic wave intensity (electromagnetic wave intensity information) and the flowability of resin and conducted intensive studies. The electromagnetic wave intensity information refers to information including the intensity of electromagnetic waves reflected by the resin surface when the resin is irradiated with the electromagnetic waves. The inventors found that the flowability of resin can be estimated based on the electromagnetic wave intensity information including the intensity of electromagnetic waves and conceived the present invention. That is, the above object of the present invention is achieved by the following.

### SUMMARY OF THE INVENTION

To achieve at least one of the abovementioned objects, according to an aspect of the present invention, there is provided a resin molding method including: a physical property estimation step in which a resin is irradiated with electromagnetic waves including near-infrared rays, electromagnetic wave intensity of electromagnetic waves reflected by a surface of the resin is estimated, and flowability of the resin is estimated, based on electromagnetic wave intensity information that includes the electromagnetic wave intensity; and a molding step in which a molding condition is adjusted, based on the estimated flowability of the resin, and the resin is molded under the adjusted molding condition.

According to an aspect of the present invention, there is provided a resin sorting method including: a step in which a resin is irradiated with electromagnetic waves including near-infrared rays, electromagnetic wave intensity of electromagnetic waves reflected by a surface of the resin is estimated, and flowability of the resin is estimated, based on electromagnetic wave intensity information that includes the electromagnetic wave intensity; and a step in which a molding condition is adjusted, based on the estimated flowability of the resin, and the resin is sorted according to the adjusted molding condition.

Although the mechanism of the effect of the present invention is not clear, the inventors infer the mechanism as follows.

When a resin is irradiated with electromagnetic waves, heat is conducted from the resin surface to the inside of the resin. Accordingly, the state of the resin surface irradiated with the electromagnetic waves changes. The resin surface that is irradiated with the electromagnetic waves and that reflects the electromagnetic waves is also referred to as the “reflection surface of the resin”. When the resin is irradiated with electromagnetic waves, the state of the reflection surface of the resin changes depending on the melting rate of the resin.

It is supposed that, due to the change in the state of the reflection surface of the resin as described above, the reflectance data of electromagnetic waves that hit the resin changes. The reflectance data refers to reflectance or data obtained by converting the reflectance. It is also supposed that the heat conduction inside the resin and the melting rate of the resin affect the melt mass flow rate (MFR) of the resin. Therefore, it is supposed that the reflectance data of electromagnetic waves, which reflects the state of the reflection surface of the resin, correlates with the melt mass flow rate (MFR) of the resin.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a flowchart of a resin molding method according to an embodiment;

FIG. 2 is a graph showing the relation between the wavelength of reflected electromagnetic waves and reflectance data;

FIG. 3 is a calibration curve that shows the relation between ΔR1/ΔR2 and the melt mass flow rate (MFR);

FIG. 4 is a schematic diagram of an apparatus that is used in an example of the present invention to heat a resin and measure the electromagnetic wave intensity; and

FIG. 5 is a schematic diagram of an apparatus that is used in an example of the present invention to heat a resin and measure the electromagnetic wave intensity.

### DETAILED DESCRIPTION

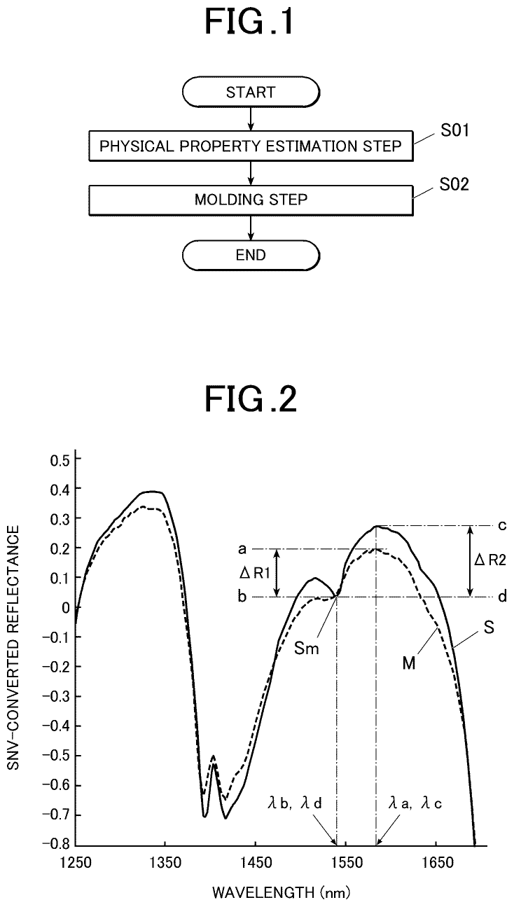

Hereinafter, one or more embodiments of the present invention will be described with reference to the drawings. However, the scope of the invention is not limited to the disclosed embodiments. As illustrated in FIG. 1, according to an embodiment of the present invention, the resin molding method includes a physical property estimation step S01 and a molding step S02. In the physical property estimation step S01, a resin is irradiated with electromagnetic waves; the intensity of the electromagnetic waves (electromagnetic wave intensity) is measured; and the flowability of resin is estimated. The electromagnetic waves for irradiating the resin include near-infrared rays. The electromagnetic wave intensity is the intensity of the electromagnetic waves reflected on the resin surface. The flowability of resin is estimated based on electromagnetic wave intensity information including the electromagnetic wave intensity. In the molding step S02, molding conditions are adjusted based on the estimated flowability of resin; and the resin is molded under the adjusted molding conditions. According to the above resin molding method of the present embodiment, the physical property of a resin having an unknown physical property can be estimated by a simple method. Further, according to the above resin molding method of the present embodiment, a product molded under molding conditions adjusted based on the estimated physical property can be obtained. The above-described features are technical features common to or corresponding to the following embodiment. FIG. 1 is a flowchart of the resin molding method according to the present embodiment.

It is preferable that, in the physical property estimation step S01, the flowability of resin is estimated based on the electromagnetic wave intensity information including the electromagnetic wave intensities of both the molten resin and the solid resin. The molten resin is obtained by heating a solid resin into a molten resin. The solid resin is obtained by cooling the molten resin. Thus, the physical property to be estimated is the flowability of resin. This makes it possible to estimate the flowability by a simple method, based on the electromagnetic wave intensity information including the electromagnetic wave intensities of the molten resin and the solid resin.

When the solid resin is heated to form the molten resin, the heating is preferably performed at a heating rate of 5 to 25° C./min. Then, when the molten resin is cooled to form the solid resin, the cooling is preferably performed at a cooling rate of 1 to 10° C./min. By setting the heating rate and the cooling rate within specific ranges, it is possible to obtain the electromagnetic wave intensity information having a better correlation with the flowability of resin.

It is preferable that, in the physical property estimation step S01, the flowability of resin is estimated using ΔR1/ΔR2 as the electromagnetic wave intensity information. The reflectance of the electromagnetic wave of each of the molten resin and the solid resin is calculated, based on the electromagnetic wave intensity of the molten resin and the solid resin. Therefore, the reflectance is one piece of “electromagnetic wave intensity information including the electromagnetic wave intensity”. Herein, reflectance or “data obtained by converting reflectance” is referred to as reflectance data. Since reflectance data is either reflectance or “data obtained by converting reflectance”, reflectance data is one piece of “electromagnetic wave intensity information including the electromagnetic wave intensity”. Further, the following ΔR1, ΔR2, and ΔR1/ΔR2 calculated from reflectance data are also “electromagnetic wave intensity information including electromagnetic wave intensity”. ΔR1 is a value obtained by subtracting reflectance data b from reflectance data a. Regarding the reflectance data a and b, two specific wavelengths (λa, λb) are selected in the reflectance data of the molten resin. The reflectance data a is reflectance data of the longer wavelength λa. The reflectance data b is reflectance data of the shorter wavelength λb. ΔR2 is a value obtained by subtracting reflectance data d from reflectance data c. Regarding the reflectance data a and b, two specific wavelengths λc and λd are selected in the reflectance data of the solid resin. The reflectance data c is reflectance data of the longer wavelength λc. The reflectance data d is reflectance data of the shorter wavelength λd. ΔR1/ΔR2 is a value obtained by dividing ΔR1 by ΔR2. According to the physical property estimation step S01 as described above, it is possible to obtain The electromagnetic wave intensity information that is highly correlated with the flowability of resin. The above-described “data obtained by converting the reflectance” is, for example, data obtained by applying a conversion, such as the SNV conversion (described later), to the reflectance. The data obtained by converting the reflectance allows estimation of the flowability of resin when the above ΔR1/ΔR2 and so forth are calculated as the electromagnetic wave intensity information.

The temperature at which the solid resin is heated to change from the solid state to the molten state is defined as T1° C. It is preferable that the electromagnetic wave intensity of the molten resin is measured in a temperature range of T1 to “T1+10° C.”. Then, the electromagnetic wave intensity of the solid resin is preferably measured in a temperature range of 20 to 40° C. By measuring the electromagnetic wave intensity in the above temperature range, it is possible to stably obtain the electromagnetic wave intensity information having a higher correlation with the flowability of resin.

It is preferable that, in the physical property estimation step S01, the flowability of resin is estimated based on the electromagnetic wave intensity information using a calibration curve that associates the value of ΔR1/ΔR2 with the flowability of resin. With the calibration curve showing the correspondence between the value of ΔR1/ΔR2 and the flowability of resin, the flowability of resin can be estimated by a simple method. Based on the estimated flowability of resin, molding conditions are adjusted, and a molded product is obtained under the adjusted molding conditions.

Preferably, the wavelengths λa and λc are within a wavelength range of 1585 to 1605 nm. More preferably, the wavelengths λa and λc are 1595 nm. Preferably, the wavelengths λb and λd are within a wavelength range of 1535 to 1550 nm. More preferably, the wavelengths λb and λd are 1542 nm. When the wavelengths λa, λb, λc, and λd are set as described above, the correlation between the value of ΔR1/ΔR2 and the flowability of resin can be further increased. Thus, the flowability of resin can be more accurately estimated from the value of ΔR1/ΔR2. It is preferable that the wavelengths λa, λb, λc, and λd are the same as the wavelengths λa, λb, λc, and λd at the time of creating the calibration curve.

The flowability of resin to be estimated is preferably a melt mass flow rate (MFR). The MFR indicates the flowability of resin. The MFR is an important indicator when performing injection molding, in which a heat-melted resin is filled into a mold. Therefore, by estimating the MFR and adjusting the molding conditions, a good molded product can be formed.

It is preferable that, in the molding step S02, the resin is molded while molding conditions are adjusted. It is preferable that the molding conditions are adjusted while the electromagnetic wave intensity information of the resin is obtained at the time of molding. Further, it is preferable that the molding conditions are adjusted such that variation in the quality of the molded articles obtained by molding is suppressed. In this case, the molding conditions are adjusted a plurality of times during resin molding. That is, in resin molding, it is preferable that the electromagnetic wave intensity information of the resin before molding is obtained a plurality of times while the molding step is in progress; and that the molding conditions are readjusted each time the electromagnetic wave intensity information is obtained to perform resin molding. By adjusting the molding conditions a plurality of times during resin molding, it is possible to suppress fluctuations in the quality of the molded article. The electromagnetic wave intensity information is preferably obtained by sampling the resin in a cylinder of an injection-molding machine. The resin is preferably sampled every time 10 to 15 molded articles are produced before the next injection.

The physical property estimation step S01 and the molding step S02 are preferably repeated a plurality of times. That is, a cycle of the physical property estimation step S01 and the molding step S02 in this order is repeated multiple times. In this case, the molding conditions are adjusted a plurality of times during the resin molding as described above. The molding conditions are adjusted while the electromagnetic wave intensity information of the resin is obtained in molding. By adjusting the molding conditions a plurality of times during resin molding, it is possible to suppress fluctuations in the quality of the molded article.

Preferably, the molding step S02 is the step of heating and molding the resin, and the molding conditions include conditions for heating the resin. More preferably, the molding step S02 is the step of heating, melting, and molding the resin. Thus, the molding conditions can be easily adjusted based on the estimated flowability of resin.

The resin used for resin molding is preferably a recycled resin. According to the resin molding method of the present embodiment, an unknown physical property of a recycled resin can be estimated, and the recycled resin can be molded. Therefore, according to the resin molding method of the present embodiment, a recycled resin containing waste plastic or the like is preferably molded.

In one embodiment of the resin sorting method of the present invention, a resin is irradiated with electromagnetic waves including near-infrared rays. Then, the intensity of the electromagnetic waves reflected by the resin surface is measured, and the flowability of resin is estimated based on the electromagnetic wave intensity information including the electromagnetic wave intensity. In the resin sorting method of the present embodiment, the molding conditions are adjusted based on the estimated flowability of resin; and the resin is sorted based on the obtained molding conditions. Therefore, according to the resin sorting method of the present embodiment, an unknown physical property of a resin can be estimated by a simple method; and the resin can be sorted according to the molding conditions adjusted based on the estimated physical property.

In the resin sorting method of the present embodiment, the resin is preferably a recycled resin. According to the resin molding method of the present embodiment, an unknown physical property of a recycled resin can be estimated, and the recycled resin can be sorted. Therefore, according to the resin sorting method of the present embodiment, a recycled resin containing waste plastic or the like is preferably sorted.

Following is the detailed description of the present invention, constituent elements thereof, and forms and aspects for carrying out the present invention. In the present application, “to” for indicating a numerical range is used to mean that numerical values before and after “to” are included as a lower limit value and an upper limit value.

### 1. Resin Molding Method

### Physical Property Estimation Step

In the resin molding method of the present embodiment, in the physical property estimation step, the resin is irradiated with electromagnetic waves including near-infrared rays, and the electromagnetic wave intensity of the electromagnetic wave reflected by the resin surface is measured. In the physical property estimation step, the flowability of resin is estimated based on the electromagnetic wave intensity information including the electromagnetic wave intensity. Hereinafter, the electromagnetic waves reflected by the resin surface may be referred to as reflected electromagnetic waves. The intensity of the reflected electromagnetic waves may be referred to as the reflected electromagnetic wave intensity.

### Electromagnetic Waves

The electromagnetic waves for irradiating the resin include near-infrared rays. Hereinafter, the electromagnetic waves for irradiating the resin are also referred to as irradiation electromagnetic waves. Near infrared rays are electromagnetic waves having the wavelength in the range of 800 nm to 2.5 μm. The irradiation electromagnetic waves may include the entire wave length region of near infrared rays. Preferably, the irradiation electromagnetic waves include at least the wavelength region of 935 nm to 1720 nm. It is further preferable that the irradiation electromagnetic waves include the wavelength region of 1450 nm to 1650 nm. Thus, the flowability of resin can be accurately estimated based on the electromagnetic wave intensity information including the reflected electromagnetic wave intensity.

The intensity of the irradiation electromagnetic waves is preferably 10 W to 1000 W and more preferably 100 W to 400 W. By setting the intensity of the irradiation electromagnetic waves in the above range, the intensity of the reflected electromagnetic waves can be favorably measured.

A device for irradiating the resin with electromagnetic waves is not limited to a specific device as long as the device can irradiate the resin with electromagnetic waves including the above wavelength region at the above intensity. For example, the device may be HySiL 1500 (manufactured by Kahoku Lighting Solutions Corporation).

To estimate the flowability of resin based on the electromagnetic wave intensity information including the reflected electromagnetic wave intensity, it is preferable that the area of the resin to be irradiated with electromagnetic waves is within the range of 100 cm² to 500 cm². If the irradiated area is smaller than 100 cm², the accuracy of the obtained electromagnetic wave intensity information may be decreased. If the irradiated area of the resin with electromagnetic waves is too large, lots of resin and a large device are required. Therefore, the irradiated area is preferably 500 cm² or less.

The entire resin may be irradiated with electromagnetic waves at once. For another example, the entire resin may be irradiated with electromagnetic waves by running electromagnetic waves that hit part of the resin over the resin. When the electromagnetic waves are run over on the resin, the electromagnetic waves may be moved, or the resin may be moved.

The irradiation angle at which the resin is irradiated with the electromagnetic waves is preferably in the range of 0° to 60° when the angle at which the incident electromagnetic wave is parallel to the normal line of the resin surface is defined as 0°. The electromagnetic waves can hit the resin surface within a range of 0° to 90°. Thus, the resin can be efficiently irradiated with the electromagnetic waves.

### Measurement of Electromagnetic Wave Intensity

The intensity of the electromagnetic waves reflected by the resin surface (the reflected electromagnetic wave intensity) can be measured by a device capable of measuring the intensity of near-infrared rays. For example. Specim FX-17 (product name) (manufactured by Specim. Spectral Imaging Ltd.) can be used. Specim FX-17 can measure the intensity of electromagnetic waves in the range of wavelengths of near infrared rays from 900 nm to 1700 nm. By the measurement of the electromagnetic wave intensity, a spectrum that records an intensity distribution for each wavelength of the electromagnetic waves is obtained.

In the physical property estimation step, preferably, a solid resin is heated into a molten resin; the reflected electromagnetic wave intensity of the molten resin is measured; the molten resin is cooled to form a solid resin; the reflected electromagnetic wave intensity of the solid resin is measured; and the flowability of resin is estimated, based on the electromagnetic wave intensity information including the obtained two reflected electromagnetic wave intensities. Thus, the flowability of resin can be accurately estimated.

Preferably, the solid resin is heated to form a molten resin at a heating rate of 5 to 25° C./min. Further preferably, the heating rate is 10 to 20° C./min. By setting the heating rate within the above range, the flowability of resin can be estimated accurately. If the heating rate is lower than 5° C./min, it may be difficult to know the heat transfer rate of the resin itself. If the heating rate is higher than 25° C./min, overshooting in which the temperature becomes higher than the target heating temperature may occur frequently.

Preferably, the molten resin is cooled to form a solid resin at a cooling rate of 1 to 10° C./min. More preferably, the cooling rate is 5 to 10° C./min. By setting the cooling rate within the above range, the flowability of resin can be estimated accurately. If the cooling rate is lower than 1° C./min, the resin may be crystallized. If the cooling rate is higher than 10° C./min, cooling may proceed unexpectedly further, and data may not be obtained easily.

The method of heating the resin is not particularly limited, and any method can be used as long as the entire resin can be heated at a predetermined rate. For example, heating with a heat gun or irradiation of laser may be performed.

The temperature at which the reflected electromagnetic wave intensity is measured is as follows. The temperature at which the solid resin is heated to change from the solid state to the molten state is defined as T1° C. Preferably, the electromagnetic wave intensity of the molten resin is measured in the temperature range of T1 to T1+10° C. More preferably, the temperature range is T1 to T1+5° C. By measuring the reflected electromagnetic wave intensity in this temperature range, the reflected electromagnetic wave intensity can be accurately measured. Furthermore, the electromagnetic wave intensity of the solid resin is preferably measured in the temperature range of 20 to 40° C. The temperature range of 32 to 38° C. is more preferable. By measuring the reflected electromagnetic wave intensity in this temperature range, the reflected electromagnetic wave intensity can be accurately measured.

### Electromagnetic Wave Intensity Information

In the physical property estimation step, it is preferable that the reflectance of electromagnetic waves is calculated for the molten resin and the solid resin, based on the intensity of reflected electromagnetic waves of the molten resin and the solid resin. The reflectance of electromagnetic waves is the ratio (%) of the intensity of reflected electromagnetic waves to the intensity of irradiation electromagnetic waves. Therefore, the reflectance of the electromagnetic wave is one of pieces of electromagnetic wave intensity information including electromagnetic wave intensity (reflected electromagnetic wave intensity).

The electromagnetic wave intensity is expressed as a spectrum that records the distribution of intensities of electromagnetic waves for the respective wavelengths, as described above. The spectrum showing electromagnetic wave intensities is expressed by a graph in which the horizontal axis represents the wavelength and the vertical axis represents the electromagnetic wave intensity over the range of wavelengths to be measured. The reflectance data calculated based on the electromagnetic wave intensity is expressed by a graph in which the horizontal axis represents the wavelength and the vertical axis represents the reflectance.

The relation between the wavelength of the reflected electromagnetic wave and the reflectance data will be further described. FIG. 2 is a graph showing the relation between the wavelengths of reflected electromagnetic waves and reflectance data. In the graph of FIG. 2, the horizontal axis represents the wavelength (nm), and the vertical axis represents reflectance data. This reflectance data is obtained by performing SNV conversion on the reflectance. SNV is an abbreviation for standard normal variate. Hereinafter, the data obtained by performing SNV conversion on the reflectance is also referred to as the SNV-converted reflectance. In the SNV conversion, the distribution of reflectance values calculated from reflected electromagnetic wave intensities (spectrum) is regarded as a set of reflectance values; and, in the set (distribution) of reflectance values, the average of all the reflectance values is subtracted from each reflectance value. Each value obtained by subtracting the average of all the reflectance values from each reflectance value is then divided by the standard deviation of all the reflectance values. Thus, the SNV conversion is performed. That is, the reflectance data on the vertical axis is expressed by the expression: (Reflectance−Average value of all the reflectance values)/σ. In the expression, σ represents the standard deviation of all the reflectance values. Thus, the reflectance corresponding to each wavelength is converted to an SNV-converted reflectance corresponding to each wavelength. The graph of FIG. 2 can be regarded as showing the spectrum showing the distribution of SNV-converted reflectance values for the respective wavelengths of reflected electromagnetic waves. That is the graph in FIG. 2 shows the relation between the wavelength of reflected electromagnetic waves and the SNV-converted reflectance. Thus, it is possible to suppress a base line shift when the electromagnetic wave intensity spectrum of the reflected electromagnetic waves is measured. In the present specification, the record of the distribution of intensities of electromagnetic waves for the respective wavelengths is referred to as a spectrum, as described above. Further, in the present specification, the record of the distribution of reflectance data calculated from the intensity distribution is also referred to as a spectrum.

Preferably, ΔR1/ΔR2 is calculated from the relation between the wavelength of reflected electromagnetic waves and the SNV-converted reflectance. There is a high correlation between ΔR1/ΔR2 and the flowability of resin, in particular. MFR. In FIG. 2, the graph M shows the relation between the wavelength of reflected electromagnetic waves and the SNV-converted reflectance for molten resin. The graph of FIG. 2 may be referred to as the graph of wavelength and SNV-converted reflectance. The graph S shows the relation between the wavelength of reflected electromagnetic waves and the SNV-converted reflectance for solid resin. In the graph M, two specific wavelengths are selected; the SNV-converted reflectance at the longer wavelength λa of the two wavelengths is represented by a; and the SNV-converted reflectance at the shorter wavelength λb is represented by b. The value obtained by subtracting b from a is defined as ΔR1. Similarly, in the graph S, two specific wavelengths are selected; the SNV-converted reflectance at the longer wavelength λc is represented by c; and the SNV-converted reflectance at the shorter wavelength λd is represented by d. The value obtained by subtracting d from c is defined as ΔR2. Then. ΔR1/ΔR2 is calculated. Preferably, ΔR1/ΔR2 is used as the electromagnetic wave intensity information to estimate the flowability of resin. Preferably, the wavelength λa is equal to the wavelength λc. Preferably, the wavelength λb is equal to the wavelength λd. Furthermore, it is preferable that the wavelengths λa to λd are the same as the wavelengths λa to λd at the time of creating the calibration curve. In the present embodiment, the SNV-converted reflectance is used as the reflectance data. However, the flowability of resin can also be estimated by using the reflectance as the reflectance data.

Based on the graph of wavelength and SNV-converted reflectance, the temperature at which the resin melts can be determined. The graph S, which is a spectrum of the intensity of electromagnetic waves reflected from solid resin, has an absorption peak Sm. The absorption peak Sm is a downwardly-convex minimum value between 1450 nm and 1650 nm. In the graph of FIG. 2, the absorption peak Sm is near the wavelength of 1550 nm. Such an absorption peak Sm is formed in the graph of wavelength and SNV-converted reflectance for solid resin. On the other hand, the graph M, which is a spectrum of the intensity of electromagnetic waves reflected from molten resins, does not have an absorption peak, which is a downwardly-convex minimum value between 1450 nm and 1650 nm. The graph S has upwardly convex maximum regions on the long wavelength side and the short wavelength side of the wavelength corresponding to the absorption peak Sm. On the other hand, although the graph M has a maximum region on the long wavelength side of the wavelength corresponding to the absorption peak Sm in the graph S, the graph M does not have a maximum region on the short wavelength side. This shows that when solid resin becomes molten resin by heating, the local maximum region on the short wavelength side of the wavelength corresponding to the absorption peak Sm disappears, and the absorption peak Sm also disappears. That is, when the absorption peak Sm formed in the graph S of solid resin disappears, the solid resin becomes the molten resin. In view of the above, the graph of wavelength and SNV-converted reflectance is created based on the reflected electromagnetic wave intensity for each specific temperature while the temperature of the solid resin is increased; and the temperature measured when the absorption peak Sm disappears is a temperature at which the resin is at least melted. It is preferable that the intensity of reflected electromagnetic waves be measured in a temperature range of T1 to T1+10° C. Therefore, it is preferable that the difference between the temperature at which the absorption peak Sm disappears for the first time and the temperature at which the absorption peak Sm is present in the solid state and that is measured immediately before the absorption peak Sm disappears for the first time be less than 30° C. Thus, the temperature at which the absorbance peak Sm disappears for the first time is included at least in the temperature range of T1 to T1+10° C.

### Estimation of Flowability of Resin

In the resin molding method of the present embodiment, the estimated flowability of resin is used for adjusting molding conditions in resin molding. The estimated flowability of resin is not particularly limited as long as it is used for adjusting molding conditions in resin molding. The estimated flowability of resin is preferably a melt mass flow rate (MFR). The molding conditions adjusted based on the MFR can produce favorable molded articles.

The measurement of MFR is performed by a method in accordance with “JIS K 7210-1” and is expressed in grams of resin per 10 minutes. Specifically, first, a cylinder having a die attached to its bottom is heated. The heated cylinder is then filled with resin. After preheating for 5 minutes, a load is applied to the cylinder, so that the resin is extruded from the die at the bottom of the cylinder. The resin amount (g) per unit time (10 minutes) at this time is measured and defined as MFR. Thus, the MFR can be measured.

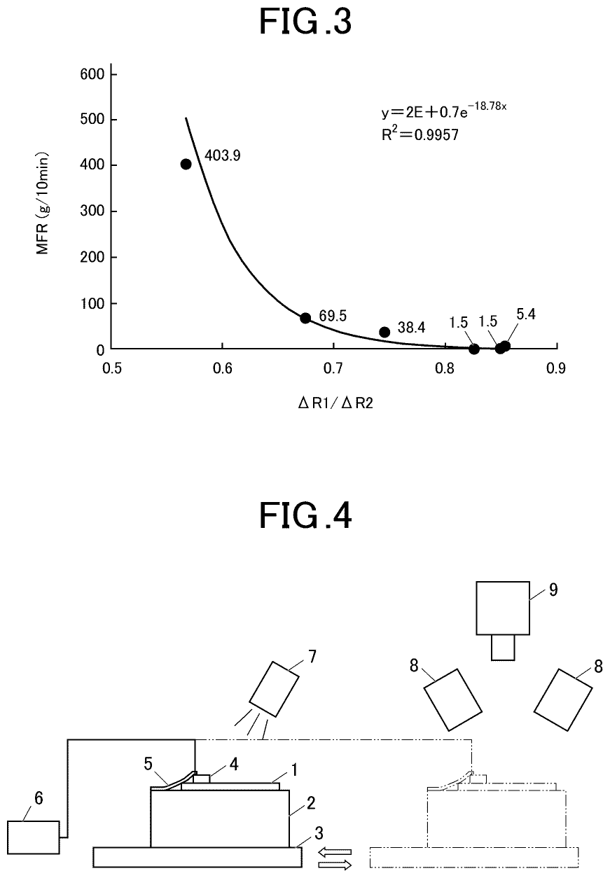

It is preferable that, in the physical property estimation step, the flowability of resin is estimated based on the electromagnetic wave intensity information using the calibration curve that associates the value of ΔR1/ΔR2 with the flowability of resin. The electromagnetic wave intensity information is preferably “ΔR1/ΔR2” of the resin the physical property of which is to be estimated. As described above, the flowability of resin is preferably the melt mass flow rate (MFR). FIG. 3 is a calibration curve that shows the relation between ΔR1/ΔR2 and the melt mass flow rate (MFR).

The calibration curve can be prepared as follows, for example. The MFRs of multiple resins are measured. The types of resins for measuring the MFRs are not particularly limited. The resins preferably include a resin having an MFR value of 400 (g/10 min) or greater and a resin having an MFR value of 2 (g/10 min) or less. The resin used for creating the calibration curve may be HDPE, for example. HDPE is an abbreviation for high-density polyethylene. The number of resins for measuring the MFR is not particularly limited but is preferably 5 or greater. It is also preferable that the values of ΔR1/ΔR2 of resins for measuring the MFR are at appropriate intervals suitable for preparing the calibration curve. When recycled resins are molded, each of the resins that have different MFRs and that are used to create the calibration curve can be appropriately determined, based on the MFR range of resins collected from the market.

The reflected electromagnetic wave intensity of the resin for measuring MFR is measured as the electromagnetic wave intensity information by the above method. Then. ΔR1/ΔR2 is calculated by the above method. Preferably, as shown in FIG. 3, a mathematical formula representing the relation between the MFR and the ΔR1/ΔR2 of each resin is obtained, and the formula is used as the calibration curve. It is also preferable that, when the formula (regression curve) indicating the relation between ΔR1/ΔR2 and MFR is obtained, the square of the correlation coefficient (R²) is 0.75 or greater.

The method for estimating the MFR of resin is as follows. The reflected electromagnetic wave intensity of resin is measured by the method described above, and the electromagnetic wave intensity information “ΔR1/ΔR2” is calculated by the method described above, from the obtained value of ΔR1/ΔR2, the value of MFR is read using the calibration curve. The MFR may be calculated from the value of ΔR1/ΔR2 using a mathematical formula that is the basis of the calibration curve.

### Resin

The resin used in the resin molding method of the present embodiment is preferably a thermoplastic resin. The resin may be a mixture of multiple resins. Preferably, the resin is molded by injection molding. The resin may be a recycled resin made of waste plastics as a raw material. According to the resin molding method of the present embodiment, when it is necessary to identify the MFR value for each resin used for molding (e.g., a recycled resin made of waste plastic as a raw material), the MFR can be identified by a simple method, the molding conditions can be adjusted, and the resin molding can be performed. The resin used for molding in the resin molding method of the present embodiment preferably has an MFR value of 0.2 (g/10 min) or greater and 400 (g/10 min) or less.

It is preferable that the resin used for molding in the resin molding method of the present embodiment has a reflectance of 20% or greater for electromagnetic waves having a specific wavelength. The reflectance is more preferably 25% or greater and further preferably 40% or greater. The reflectance is preferably as high as possible, but the upper limit thereof is about 90%. When the reflectance of resin is in the above range, the physical property of resin can be accurately estimated in the physical property estimation step. The electromagnetic waves having the specific wavelength as mentioned above are the following two types of electromagnetic waves. One is the electromagnetic wave having a wavelength in the range of 1585 nm to 1605 nm. The other is the electromagnetic wave having a wavelength in the range of 1535 nm to 1550 nm. It is preferable that the reflectances of these two types of electromagnetic waves are both within the above-described range. In particular, both the reflectance of electromagnetic waves having the wavelength of 1595 nm and the reflectance of electromagnetic waves having the wavelength of 1542 nm are preferably 20% or greater, more preferably 25% or greater, and further preferably 40% or greater.

As the resin used for molding in the resin molding method of the present embodiment. HDPE can be used, for example. Further, a mixture of a plurality of kinds of resins may be used in the resin molding method of the present embodiment.

In the resin molding method of the present embodiment, as described above, a recycled resin produced from waste plastic as a raw material can be used as the resin for molding. In this case, the waste plastic may be a pre-consumer material or a post-consumer material. The pre-consumer material refers to a material that is not used as a product in the market. Examples of the pre-consumer material include scraps in a product manufacturing process, defective products, and disposal of inventory. The post-consumer material refers to a material shipped to the market as a product. Post-consumer materials include both used and unused materials. The above-described recycled resin may contain one kind of raw material or may be a mixture of multiple kinds of raw materials. The raw materials of the recycled resin may be multiple kinds of waste plastic or may be one kind of waste plastic and other materials. The raw materials of the recycled resin may be multiple kinds of waste plastic and other materials or may be one kind of waste plastic.

### Molding Step

The molding step in the resin molding method of the present embodiment is the step of adjusting molding conditions based on the estimated flowability of resin and molding the resin under the adjusted molding conditions. In the resin molding method of the present embodiment, the molding step is preferably the step of molding the resin by injection molding. In the molding step, for example, a resin is heated and melted; the molten resin is filled in a mold; the resin in the mold is cooled and solidified; and the solidified resin is removed from the mold to obtain a molded article. Thus, the molding step is preferably the step of heating and molding the resin.

An injection molding machine is used for injection molding. The injection molding machine preferably includes: an injection device that melts a resin and fills a mold with the resin; and a mold that molds the molten resin to produce a molded article. Preferably, the injection molding machine further includes a mold clamping device that opens and closes the mold.

Examples of the molding conditions in the molding step include conditions under which the resin is heated. More specifically, examples of the molding conditions include: a temperature at which resin is melted in the injection device; an injection pressure at the time of filling the mold with resin by the injection device; a temperature of resin in the mold; and a temperature of the mold. Among these, it is particularly preferable that the temperature at which the resin is melted and the injection pressure are adjusted, based on the flowability of resin (e.g., MFR) as the molding conditions of the resin.

When the resin molding method of the present embodiment is carried out, it is preferable that the relation between the flowability of resin (e.g., MFR) and the molding conditions to be adjusted in the injection molding machine is confirmed in advance. It is also preferable that the molding conditions are obtained from the flowability of resin (e.g., MFR) estimated in the physical property estimation step and the above-mentioned relation. Then, it is preferable to mold a resin under the obtained molding conditions.

For example, when the flowability of resin is expressed by MFR, the molding conditions are preferably determined by performing injection molding of multiple resins having different MFRs. It is preferable that each MFR of the plurality of resins having different MFRs described above ranges over an MFR range which is assumed to have a possibility of being estimated in the physical property estimation step. Furthermore, it is preferable to select a sufficient number of resin and determine the molding conditions to the extent that the molding conditions can be adjusted no matter what the estimated value of the MFR of the resin to be molded may be within the aforementioned assumed range of the MFR.

The molding step is preferably a step of molding the resin while adjusting molding conditions. It is preferable that the molding conditions are adjusted while the electromagnetic wave intensity information of the resin is obtained at the time of molding. It is preferable that the molding conditions are adjusted such that variation in the quality of the molded articles obtained by molding is suppressed. In this case, the molding conditions are adjusted a plurality of times during resin molding. By adjusting the molding conditions a plurality of times during resin molding, it is possible to suppress fluctuations in the quality of the molded article. The electromagnetic wave intensity information is preferably obtained by sampling the resin in a cylinder of an injection-molding machine. The resin is preferably sampled every time 10 to 15 molded articles are produced before the next injection.

The physical property estimation step and the molding step are preferably repeated a plurality of times. That is, a cycle of the physical property estimation step and the molding step in this order is repeated multiple times. In this case, the molding conditions are adjusted a plurality of times during resin molding. The molding conditions are adjusted while the electromagnetic wave intensity information of the resin is obtained in molding. By adjusting the molding conditions a plurality of times during resin molding, it is possible to suppress fluctuations in the quality of the molded article.

### 2. Resin Sorting Method

In the resin sorting method according to the present embodiment, first, a resin is irradiated with electromagnetic waves including near-infrared rays, and the intensity of the electromagnetic waves reflected by the resin surface is measured. In the resin sorting method of the present embodiment, the flowability of resin is estimated based on the electromagnetic wave intensity information including the electromagnetic wave intensity. This is the same as the physical property estimation step in the resin molding method of the present embodiment. In the resin sorting method of the present embodiment, it is preferable that the molding conditions are adjusted based on the estimated flowability of resin and that the resin is sorted in accordance with the obtained molding conditions. The molding conditions are adjusted in the same manner as the adjustment of the molding conditions in the resin molding method of the present embodiment. Resins having the same molding conditions can be mixed and molded.

In the resin sorting method of the present embodiment, the resin to be sorted is preferably a recycled resin. When recycled resins are sorted, recycled resins having the same molding conditions can be collected, mixed and molded. Thus, recycled resins can be efficiently used.

### EXAMPLE

Hereinafter, the present invention will be specifically described with reference to example(s), but the present invention is not limited thereto. Note that the operations in the following Examples were performed at room temperature (25° C.) unless otherwise specified.

### Example 1

### (1) Resin Molding Method

### 1. Physical Property Estimation Step

### Resin

As a resin to be molded, a market-recovered product A was used. The market-recovered product A is a resin recovered from the market of used container packaging plastics. The market-recovered product A is HDPE as a resin and has an MFR of 1.25 g/10 min. The market-recovered product A had a reflectance of 84.83% for electromagnetic waves having the wavelength of 1595 nm and a reflectance of 54.60% for electromagnetic waves having the wavelength of 1542 nm. The reflectances are listed in Table 1. In Table 1, “reflectance 1” is the reflectance at which the electromagnetic waves having the wavelength of 1595 nm are reflected by the resin. The “reflectance 2” is the reflectance at which the electromagnetic waves having the wavelength of 1542 nm are reflected by the resin. The market-recovered product A was visually white.

The market-recovered product A was coarsely pulverized using a Plastic Pulverizer type 14 (E014) (manufactured by FUJITEX Corporation). Next, the coarsely pulverized market-recovered product A was put into an extruder (HAAKE Process 11 (manufactured by Thermo Scientific)) and kneaded and extruded to form strands. The obtained strands were pelletized using a pelletizer (LNS-50SCE manufactured by GIKEN KOHKI Company Limited).

The pellets of the market-recovered product A were dried at 80° C. for 4 hours. Thereafter, the dried pellets were molded using an injection-molding machine (Babyplast manufactured by Rambaldi) to obtain a test piece having a size of 80 mm (length)×10 mm (width)×4.0 mm (height). The cylinder preset temperature of the injection-molding machine was set to 260° C. and the mold temperature was set to 50° C. The molding conditions in preparation of the test piece may be changed depending on the resin.

### Measurement of Electromagnetic Wave Intensity

To emit electromagnetic waves, two HySiL1500 (trade name) (manufactured by Hebei Writing Solutions Co., Ltd) were used as light sources. The electromagnetic waves having the wavelength in the range of 900 nm to 2150 nm were used for measuring the electromagnetic wave intensity. The electromagnetic wave intensity of the two light sources was 200 W.

As a camera for measuring the intensity of near-infrared rays, Specim FX-17 (trade name) (manufactured by Specim. Spectral Imaging Ltd.) was used.

The resin was heated by a 1000 W heat gun as a heating source. As the heat gun, PJ 208A (manufactured by ISHIZAKI ELECTRIC MFG.CO., LTD.) was used.

The electromagnetic wave intensity was measured as follows. First, as illustrated in FIG. 4, the test piece 1 was placed on a heat-resistant stand 2, and a thermocouple 4 was mounted on the test piece 1. Then, the test piece 1 and the thermocouple 4 were fixed to the heat-resistant stand 2 using a heat-resistant tape. The thermocouple 4 was connected to a temperature display part 6. Next, the heat-resistant stand 2 was placed on the slide plate 3. The slide plate 3 can slide between the position where the heat source 7 is installed and the position where the light source 8 and the camera 9 are installed. The slide plate 3 slides on a rail (not illustrated). The position where the heat source 7 is installed is also called a heating position. The position where the light source 8 and the camera 9 are installed is also called a camera position. Next, the test piece 1 is heated at the heating position, then the slide plate 3 is moved to the camera position by sliding, and the test piece 1 is irradiated with electromagnetic waves. Thus, the reflected electromagnetic wave intensity can be measured. The heat source 7, the light source 8, the camera 9, and a rail (not illustrated) were fixed to an aluminum rack (not illustrated). FIG. 4 is a schematic diagram of an apparatus that is used in the example of the present invention to heat a resin and measure the electromagnetic wave intensity.

The electromagnetic wave intensity was measured for (i) the market-recovered product A in a molten state (molten resin) and (ii) the market-recovered product A in a solid state (solid resin) obtained by solidifying the market-recovered product A in the molten state. The solid market-recovered product A was heated while the electromagnetic wave intensity thereof was measured, and when it was confirmed that the market-recovered product A became molten, the electromagnetic wave intensity of the market-recovered product A in the molten state was measured. To measure the electromagnetic wave intensity of the market-recovered product A in the molten state, the electromagnetic wave intensity of the solid market-recovered product A was repeatedly measured while the temperature was increased.

The electromagnetic wave intensity of the market-recovered product A in the molten state was measured as follows. First, as illustrated in FIG. 4, the slide plate 3 on which the test piece 1 and the heat-resistant stand 2 were placed was arranged at a heating position. Then, it was heated to 100° C. by the heat source 7. At this time, the temperature was raised at a rate of 20° C./min.

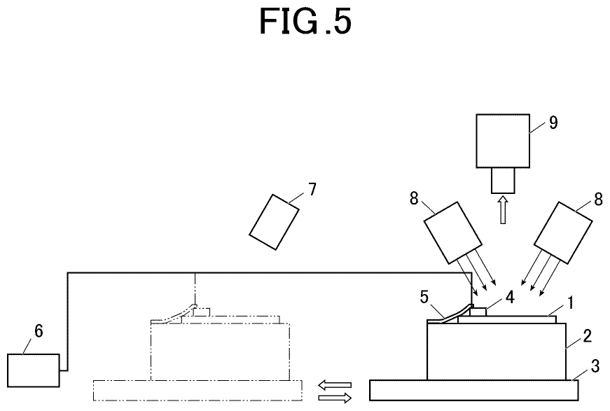

Thereafter, as shown in FIG. 5, the slide plate 3 on which the test piece 1 and the heat-resistant stand 2 were placed was slid to the camera position. When the temperature of the test piece 1 reached 95° C. by natural cooling, electromagnetic waves were emitted from the light source 8, and the intensity of the reflected electromagnetic waves was measured by the camera 9. FIG. 5 is a schematic diagram of the apparatus that is used in the example of the present invention to heat a resin and measure the electromagnetic wave intensity.

The camera 9 measured the intensity of reflected electromagnetic waves in a wavelength range of 935 nm to 1720 nm corresponding to the wavelength of near-infrared rays. Based on the obtained intensity distribution of the electromagnetic waves of each wavelength, the reflectance of each wavelength was calculated. Then, as in the graph of FIG. 2, the relation between the wavelength and the SNV-converted reflectance was obtained (not illustrated) with the wavelength taken on the horizontal axis and the SNV-converted reflectance taken on the vertical axis.

Thereafter, the heating at the heating position and the measurement of the reflected electromagnetic wave intensity at the camera position were repeated while the temperature was increased by 20° C. When the absorption peak (corresponding to Sm in the graph of FIG. 2) having a downwardly convex minimum value disappeared in the relation between the wavelength and the SNV-converted reflectance, it was determined that the market-recovered product A was melted. When the intensity of reflected electromagnetic waves of the market-recovered product A in the molten state was measured, ΔR1 was 0.2115. ΔR1 is a value obtained by subtracting the value of the SNV-converted reflectance at the wavelength of 1542 nm (λb) from the value of the SNV-converted reflectance at the wavelength of 1595 nm (λa). The SNV-converted reflectance at the wavelength of 1595 nm (λa) is the reflectance data a. The SNV-converted reflectance at the wavelength of 1542 nm (λb) is the reflectance data b. The state where the absorption peak having a downward convex minimum value disappears corresponds to the graph M of FIG. 2.

The electromagnetic wave intensity of the solid market-recovered product A was measured as follows. After the reflected electromagnetic wave intensity of the market-recovered product A in the molten state was measured, the market-recovered product A was moved to the heating position and cooled to 35° C. at a rate of 10° C./min. The product A was cooled by air blowing. Thereafter, the market-recovered product A was moved to the camera position, and the reflected electromagnetic wave intensity was measured to obtain the relation between the wavelength and the SNV-converted reflectance (corresponding to graph S of FIG. 2). At this time, ΔR2 was 0.2390. ΔR2 is a value obtained by subtracting the value of the SNV-converted reflectance at the wavelength of 1542 nm (λd) from the value of the SNV-converted reflectance at the wavelength of 1595 nm (λc). The SNV-converted reflectance at the wavelength of 1595 nm (λc) is the reflectance data c. The SNV-converted reflectance at the wavelength of 1542 nm (λd) is the reflectance data d.

Based on the obtained ΔR1 and ΔR2, the value of ΔR1/ΔR2 was 0.885.

Using the calibration curve of FIG. 3, which shows the relation between ΔR1/ΔR2 and MFR, an estimated value of MFR was obtained from the value of ΔR1/ΔR2. The estimated value of MFR was 1.2 (g/10 min). The MFR of the market-recovered product A was measured by the following “MFR measurement method” described below. The measured MFR of the market-recovered product A was 1.25 (g/10 min). The measurement results are shown in Table 1. Table 1 shows the result of evaluating the estimation accuracy in the physical property estimation step of the resin molding method of the example 1. In Table 1, “A” in the column of resin represents the market-recovered product A. The “estimation accuracy” indicates the ratio of an estimated value to an actually measured value of MFR.

TABLE I

| | | | | MFR | | | | | |
|---|---|---|---|---|---|---|---|---|---|
| | SNV-CONVERTED | | | (g/min) | | ESTIMATION | | | COLOR |
| | REFLECTANCE | | | ESTIMATED | MEASURED | ACCURACY | REFLECTANCE | REFLECTANCE | OF |
| RESIN | ΔR1 | ΔR2 | ΔR1/ΔR2 | VALUE | VALUE | (%) | 1 (%) | 2 (%) | RESIN |
| A | 0.2115 | 0.2390 | 0.885 | 1.2 | 1.25 | 96.9 | 84.83 | 54.60 | WHITE |
| B | 0.2200 | 0.2650 | 0.830 | 3.4 | 3.5 | 96.8 | 79.32 | 48.07 | WHITE |
| C | 0.2040 | 0.2730 | 0.747 | 16.1 | 16 | 100.5 | 75.65 | 43.04 | WHITE |
| D | 0.2300 | 0.3330 | 0.691 | 46.5 | 46 | 101.1 | 82.24 | 42.85 | WHITE |
| E | 0.2400 | 0.3750 | 0.640 | 120.5 | 125 | 96.4 | 79.47 | 34.65 | WHITE |
| F | 0.3000 | 0.4910 | 0.611 | 207.8 | 220 | 94.5 | 69.71 | 30.53 | WHITE |
| G | 0.3200 | 0.5400 | 0.593 | 293.8 | 325 | 90.4 | 76.77 | 27.33 | WHITE |
| H | 0.3500 | 0.6100 | 0.574 | 418.1 | 473 | 88.4 | 82.43 | 28.27 | WHITE |
| I | 0.2380 | 0.4100 | 0.580 | 368.6 | 430 | 85.7 | 81.69 | 32.59 | RED |
| J | 0.2100 | 0.2200 | 0.955 | 0.3 | 0.45 | 72.9 | 75.26 | 54.26 | GRAY |
| K | 0.3700 | 0.4400 | 0.841 | 2.8 | 3.1 | 89.4 | 68.35 | 46.68 | ORANGE |

### MFR Measurement Method

The MFR of resin is determined by a method conforming to “JIS K 7210-1” by using a melt indexer G-02 (manufactured by Toyo Seiki Seisaku-sho. Ltd). The resin pellets are precisely weighed by 7 g and placed in a cylinder at 230° C. A load of 5 kg is applied to the inside of the cylinder to measure the mass per 10 minutes of the resin extruded from the die at the bottom of the cylinder. The obtained mass per 10 minutes of the resin is the MFR.

### Method of Creating Calibration Curve

The values of ΔR1/ΔR2 of the respective resins having different MFRs are obtained by the same method described in the above <Resin> and <Measurement of electromagnetic wave intensity>. Herein, the market-recovered product A described in <Resin> and <Measurement of electromagnetic wave intensity> is replaced with the respective resins having different MFRs. Further, the resins used for creating the calibration curve were six kinds of resins the compositions of which were known. The six kinds of resins were R-PE, R-PP, R-PA, R-PET, R-PBT, and R-POM.

The electromagnetic wave intensity of the molten resin was measured at the temperature of 110° C. Therefore, the operation of repeatedly measuring the electromagnetic wave intensity of the solid resin while increasing the temperature was not performed to measure the electromagnetic wave intensity of the resin in the molten state.

The MFRs of the above six kinds of resins were measured by the above MFR measurement method.

The calibration curve shown in FIG. 3 was prepared from the obtained ΔR1/ΔR2 values and the MFR values of the respective resins. Table 1 shows the values of ΔR1/ΔR2 and the MFR values of the respective resins. The formula for the calibration curve was “y=2×10⁷×e^{-18.78x}, R²=0.9957”. In Table II, R-POM represents recycled polyoxymethylene. R-PP represents recycled polypropylene. R-PE represents recycled polyethylene. R-PET represents recycled polyethylene terephthalate. R-PA represents a recycled polyamide and specifically represents a recycled nylon. R-PBT represents recycled polybutylene terephthalate.

TABLE II

| RESIN | ΔR1/ΔR2 | MFR(g/min) |
|---|---|---|
| R-POM | 0.5673 | 403.9 |
| R-PP | 0.6754 | 69.5 |
| R-PE | 0.7448 | 38.4 |
| R-PET | 0.8507 | 1.5 |
| R-PA | 0.8269 | 1.5 |
| R-PBT | 0.8546 | 5.4 |

### 2. Molding Step

The molding was performed by injection molding. As an injection-molding machine, “Babyplast” manufactured by Rambaldi was used. The injection molding machine includes: an injection device that melts a resin and that fills a mold with the resin; and a mold that molds the molten resin to produce a molded article. The injection device has a horizontal structure. The injection device heats a resin charged in a hopper, injects the resin into the mold with a screw, and finally takes out the resin from the mold.

For this injection molding machine, molding conditions corresponding to the respective resins having different MFRs were determined in advance. Therefore, when the MFR of a resin was determined, the molding conditions could be adjusted corresponding to the MFR, and the resin could be molded. The MFR values based on which the molding conditions were determined beforehand can be determined as appropriate and may be increased as necessary.

Since the estimated MFR value of the market-recovered product A was 1.2 (g/10 min), the molding conditions of the injection-molding machine were adjusted based on this estimated MFR value. Specifically, the plasticization temperature was set to 270° C.; the chamber temperature was set to 260° C., the nozzle temperature was set to 220° C.; the primary pressure was set to 12 MPa; and the secondary pressure was set to 6 MPa. Herein, the plasticization temperature is a temperature at which a resin is melted, and the primary pressure is an injection pressure.

Using the injection molding apparatus, the market-recovered product A was molded based on the adjusted molding conditions to produce a molded article. The molded article was satisfactory with no sink marks or burrs.

### Accuracy of Estimated MFR Value

For market-recovered products B to K, resin molding was performed by the resin molding method of the above example. For each of the resins (market-recovered products B to K), ΔR1/ΔR2 was obtained; the MFR was estimated; and the MFR was measured. Then, the accuracy of the estimated MFR values was obtained. The results are shown in Table 1. As described above, the estimation accuracy is expressed as a ratio of an estimated MFR value to an actually measured MFR value. The estimation accuracy is preferably as close to 100% as possible. When the absolute value of the difference between 100% and the estimation accuracy is 30% or less, the resin is suitable to be used for molding in the resin molding method of the present invention. In Table 1. B to K in the column of resin represent the market-recovered products B to K. The reflectance 1 (%) and the reflectance 2 (%) of the market-recovered products B to K are shown in Table 1. The visual colors (resin colors) of the market-recovered products B to K are listed in Table 1.

The market-recovered product B is a resin recovered from the market of used electrical components, and the type of resin is R-PBT. The market-recovered product C is a resin recovered from the market of used cars, and the type of resin is R-PP. The market-recovered product D is a resin recovered from the market of used cars, and the type of resin is R-PP. The market-recovered product E is a resin recovered from the market of used containers and packages, and the type of resin is R-LDPE. R-LDPE denotes recycled low-density polyethylene. The market-recovered product F is a resin recovered from the market of used containers and packages, and the type of resin is R-LDPE. The market-recovered product G is a resin recovered from the market of used containers and packages, and the type of resin is R-PP. The market-recovered product H is a resin recovered from the market of used electrical parts, and the type of resin is R-POM. The market-recovered product I is a resin recovered from the market of used building materials, and the type of resin is R-POM. The market-recovered product J is a resin recovered from the market of used beverage containers, and the type of resin is R-PET. The market-recovered product K is a resin recovered from the market of used fishing nets, and the type of resin is R-PA.

The correlation between the MFR and the electromagnetic wave intensity information (ΔR1) alone, which includes the electromagnetic wave intensity of the molten resin, was not obtained. Further, the correlation between the MFR and an absorption peak corresponding to the absorption peak Sm (see FIG. 2) in the reflectance value without SNV conversion was not obtained. Further, the correlation between the MFR and the absorption peak Sm in the graph of wavelength and SNV-converted reflectance was not obtained.

### Example 2

### (2) Resin Sorting Method

By the physical property estimation step of the resin molding method of the above-described example 1, The MFRs were estimated; the molding conditions were adjusted based on the estimated MFRs; and the resins were sorted according to the obtained molding conditions.

Sorting of resins was performed on the market-recovered products A to K.

Based on the molding conditions obtained from the estimated MFRs of the respective resins, the market-recovered products A, B, and K were sorted (selected) as resins having the same molding conditions. The market-recovered resins C to J were sorted (selected) as resins having different molding conditions. Thus, it was found that the market-recovered products A, B, and K could be mixed and molded.

According to the present invention, it is possible to provide a resin molding method that allows estimation of an unknown physical property of a resin by a simple method, adjustment of molding conditions based on the estimated physical property, and molding of the resin under the adjusted molding conditions. Although embodiments of the present invention have been described and shown in detail, the disclosed embodiments are made for purposes of illustration and example only and not limitation. The scope of the present invention should be interpreted by terms of the appended claims.

1. A resin molding method comprising:
a physical property estimation step in which a resin is irradiated with electromagnetic waves including near-infrared rays, electromagnetic wave intensity of electromagnetic waves reflected by a surface of the resin is estimated, and flowability of the resin is estimated, based on electromagnetic wave intensity information that includes the electromagnetic wave intensity; and
a molding step in which a molding condition is adjusted, based on the estimated flowability of the resin, and the resin is molded under the adjusted molding condition.

2. The resin molding method according to claim 1, wherein in the physical property estimation step,
the resin in a solid state is heated to obtain a molten resin,
the electromagnetic wave intensity of the molten resin is measured,
the molten resin is cooled to obtain a solid resin,
the electromagnetic wave intensity of the solid resin is measured, and
based on the electromagnetic wave intensity information including the two electromagnetic wave intensities of the molten resin and the solid resin, the flowability of the resin is estimated.

3. The resin molding method according to claim 2, wherein:
the resin in the solid state is heated to obtain the molten resin at a heating rate of 5 to 25° C./minute, and
the molten resin is cooled to obtain the solid resin at a cooling rate of 1 to 10° C./minute.

4. The resin molding method according to claim 2, wherein in the physical property estimation step,
based on the electromagnetic wave intensities of the molten resin and the solid resin, a reflectance of electromagnetic waves of each of the molten resin and the solid resin is calculated,
the reflectance or data obtained by converting the reflectance is defined as reflectance data,
in the reflectance data of the molten resin, two specific wavelengths are selected; the reflectance data at a longer wavelength λa is defined as A; the reflectance data at a shorter wavelength λb is defined as B; and a value obtained by subtracting B from A is defined as ΔR1,
in the reflectance data of the solid resin, two specific wavelengths are selected; the reflectance data at a longer wavelength λc is defined as C; the reflectance data at a shorter wavelength λd is defined as D; and a value obtained by subtracting D from C is defined as ΔR2.
ΔR1/ΔR2 is calculated, and
the ΔR1/ΔR2 is used as the electromagnetic wave intensity information to estimate the flowability of the resin.

5. The resin molding method according to claim 2, wherein:
a temperature at which the solid resin changes from the solid state to a molten state by heating is defined as T1° C,
the electromagnetic wave intensity of the molten resin is measured in a temperature range of T1 to T1+10° C, and
the electromagnetic wave intensity of the solid resin is measured in a temperature range of 20 to 40° C.

6. The resin molding method according to claim 4, wherein in the physical property estimation step,
the flowability of the resin is estimated, based on the electromagnetic wave intensity information, by using a calibration curve that associates a value of ΔR1/ΔR2 with the flowability of the resin.

7. The resin molding method according to claim 4, wherein:
the wavelengths λa and λc are within a range of 1585 nm to 1605 nm, and
the wavelengths λb and λd are within a range of 1535 nm to 1550 nm.

8. The resin molding method according to claim 1, wherein the flowability of the resin to be estimated is a melt mass flow rate.

9. The resin molding method according to claim 1, wherein:
in the molding step, the resin is molded while the molding condition is adjusted, and
the molding condition is adjusted while the electromagnetic wave intensity information of the resin is obtained during molding.

10. The resin molding method according to claim 1, wherein:
in the molding step, the resin is heated and molded, and
the molding condition includes a condition related to heating of the resin.

11. The resin molding method according to claim 1, wherein the resin is a mixture of multiple kinds of resins.

12. The resin molding method according to claim 1, wherein the resin is a recycled resin.

13. The resin molding method according to claim 1, wherein the physical property estimation step and the molding step are repeated multiple times.

14. A resin sorting method comprising:
a step in which a resin is irradiated with electromagnetic waves including near-infrared rays, electromagnetic wave intensity of electromagnetic waves reflected by a surface of the resin is estimated, and flowability of the resin is estimated, based on electromagnetic wave intensity information that includes the electromagnetic wave intensity; and
a step in which a molding condition is adjusted, based on the estimated flowability of the resin, and the resin is sorted according to the adjusted molding condition.

15. The resin sorting method according to claim 14, wherein the resin is a recycled resin.
